(19) United States
(12) Patent Application Publication
(10) Pub. No.: US 2018/0160310 A1
(43) Pub. Date: Jun. 7, 2018

(54) WIRELESS COMMUNICATION DEVICE MODIFYING A COMMUNICATION ZONE

(71) Applicant: KABUSHIKI KAISHA TOSHIBA, Tokyo (JP)

(72) Inventor: Orestis GEORGIOU, Bristol (GB)

(21) Appl. No.: 15/125,117

(22) PCT Filed: Apr. 29, 2014
(86) PCT No.: PCT/GB2014/051323

§ 371 Date: Sep. 9, 2016

(51) Int. Cl. H04W 16/02; H04W 24/02

(52) U.S. Cl. CPC H04W 16/02; H04W 84/18; H04W 24/02

(57) ABSTRACT

A wireless communication device for communicating with one or more other wireless communication devices in a wireless network, the wireless communication device having a transmitter and/or receiver for respectively transmitting or receiving communication signals to or from the other communication devices, a border identification module for identifying one or more borders of a communication zone of the communication device, wherein the communication zone defines a region of space in which other communication devices in the network are potentially located and within which those other communication devices will be in direct communication range of the communication device, a communication zone estimator for estimating the size of the communication zone when taking into account any identified borders and a controller for modifying the settings of the transmitter and/or the receiver based on the estimated size of the communication zone.

### FIELD

Embodiments described herein relate generally to a wireless communication device.

### BACKGROUND

Wireless ad hoc mesh networks have a number of applications, ranging from condition monitoring, smart metering/smart grid control, smart buildings and vehicular networks to emergency services and disaster relief networks.

A mesh network is only useful if connectivity can be ensured at the most basic level. In other words, one must be able to guarantee that a given node can communicate with other nodes in the network with a certain positive probability, so guaranteeing a notion of reliability for the network. At the same time, it may be undesirable for nodes to have wholly unrestricted connectivity, as this may give rise to unnecessary interference between nodes, or compromise the privacy of data being transmitted across the network, for example.

Where systems are optimally equipped for a given set of network parameters, such systems may fail to flexibly adapt to changes in network topology and channel conditions. Conventionally, this problem has been addressed by using “topology control” methods, in which the transmitting range of nodes in the network is dynamically changed by regulating the transmit power of each node, for example, To date, however such methods have not taken into consideration the presence of obstacles and barriers to the nodes' transmission/reception; instead, these conventional methods only take into account each node's position with respect to other nodes. Consequently, such methods may have limited utility when seeking to manage connectivity between nodes in different types of physical environment.

### BRIEF DESCRIPTION OF FIGURES

Embodiments of the invention will now be described by way of example with reference to the accompanying drawings in which:

FIG. 1 shows an example of a wireless network comprising a plurality of wireless communication devices according to an embodiment;

FIG. 2 shows a series of steps as executed by a wireless communication device in accordance with an embodiment;

FIG. 3 shows an example of how the presence of a physical obstacle in the vicinity of a communication device may limit the area over which the communication device is able to communicate with other such devices, and how this may be compensated for by increasing the transmission range of the communication device;

FIG. 4 shows a series of steps as executed by a wireless communication device in accordance with an embodiment;

FIG. 5 shows a series of steps as executed by a wireless communication device in accordance with an embodiment;

FIG. 6 shows a series of steps as executed by a wireless communication device in accordance with an embodiment;

FIG. 7 shows a network of communication devices in which the communication range of each device is determined based on its proximity to a border of the network;

FIG. 8 shows results of simulations of how the probability that a communication device in the network of FIG. 7 will become isolated varies for different embodiments described herein;

FIG. 9 shows an example of a wireless network comprising a plurality of wireless communication devices according to an embodiment; and

FIG. 10 shows an example of a communication device according to an embodiment.

### DETAILED DESCRIPTION

According to a first embodiment, there is provided a wireless communication device for communicating with one or more other wireless communication devices in a wireless network, the wireless communication device having:
a transmitter and/or receiver for respectively transmitting or receiving communication signals to or from the other communication devices;
a border identification module for identifying one or more borders of a communication zone of the communication device, wherein the communication zone defines a region of space in which other communication devices in the network are potentially located and within which those other communication devices will be in direct communication range of the communication device;
a communication zone estimator for estimating the size of the communication zone when taking into account any identified borders; and
a controller for modifying the settings of the transmitter and/or the receiver based on the estimated size of the communication zone.

In some embodiments, the border identification module is configured to identify as a border the edge of another region of space that has been allocated for use by other communication devices with which said communication device is unable to establish direct communication. In some embodiments, the transmitter and/or receiver are respectively configured to transmit or receive communication signals on a specified channel and the other region of space is allocated to communication devices that have been assigned a different channel from the specified channel.

In some embodiments, the controller is configured to modify the settings of the transmitter and/or the receiver in such a way as to increase the communication range of the device. In some embodiments, the controller is configured to modify the settings of the transmitter and/or the receiver in such a way as to reduce the communication range of the device.

In some embodiments, the one or more borders include a physical feature in the vicinity of the device that is likely to block the passage of communication signals between the device and other communication devices; and/or a deployment boundary of the wireless network.

In some embodiments, the border identification module is configured to identify a geographic feature of the surrounding landscape as a network deployment boundary.

In some embodiments, the device further comprises a comparator for comparing the estimated size of the communication zone with the size of the communication zone that the communication device would be expected to have in the absence of the identified borders. The controller may be configured to determine whether or not to modify the settings of the transmitter and/or the receiver by determining if the difference between the estimated size of the communication zone and the size of the communication zone that the communication device would be expected to have in the absence of the identified borders is above a threshold. The size of the communication zone that the communication device would be expected to have in the absence of the identified borders may be defined as the area over which signals emitted from the device would remain above a threshold strength in the absence of any such borders.

Where the communication device includes a transmitter, the controller may be configured to modify the transmitter settings by modifying one or more of the carrier frequency, wavelength and amplitude of signals sent from the transmitter. Where the communication device includes a receiver, the controller may be configured to modify the receiver settings by modifying the sensitivity of the receiver.

In some embodiments, the controller is configured to modify the power of the transmitter and/or the sensitivity of the receiver by reference to a look-up table.

In some embodiments, the communication device includes both a transmitter and a receiver and the controller is configured to modify both the settings of the transmitter and the receiver based on the estimated size of the communication zone.

According to a second embodiment, there is provided a wireless network comprising a plurality of communication devices according to the first embodiment.

According to a third embodiment, there is provided a method of managing connectivity between wireless communication devices in a wireless network, the method comprising:
identifying one or more borders of a communication zone of a first wireless communication device, wherein the communication zone defines a region in which other communication devices in the network are potentially located and within which those other communication devices will be in direct communication range of the first communication device;
estimating the size of the communication zone when taking into account any identified borders; and
modifying the settings of the transmitter and/or the receiver based on the estimated size of the communication zone.

According to a fourth embodiment, there is provided a non-transitory computer readable storage medium comprising computer executable instructions that when executed by a computer will cause the computer to carry out the method of the third embodiment.

Border effects have been known to smooth-out percolation transitions and also to hinder network connectivity of wireless networks in general. That is, border effects lessen the mean degree of otherwise unconfined networks and increase the probability of isolated nodes. Depending on the context and application, border effects can therefore significantly impact performance metrics such as information flow, capacity, network robustness and reliability etc. Border effects may be a dominant factor in determining the network connectivity properties, particularly where the density of communication devices in the network is high.

Embodiments described herein seek to take the presence of border effects into consideration in order to optimise the communication between nodes in a wireless network. The communication range of each device can be modified through a decentralized power and/or coding strategy implemented along the receiver and/or transmitter chain. More specifically, the communication device can adjust its communication range in such a way as to increase (or decrease) the area of the communication zone of the device. It will be understood that here, the communication zone defines a region of space in which other communication devices are potentially located, and in which the strength of communication signals transmitted from the communication device remains large enough to ensure those signals are successfully received and interpreted by those other devices. Similarly, the communication zone defines an area over which other communication devices can be located if their own transmissions are to be successfully received and interpreted by the communication device.

It will be understood that a network border or boundary may also be defined by the edge of another region of space, where communication devices located in that region of space are unable to establish communication with the communication device and vice versa. For example, this could be the case in cellular networks and/or a distributed antenna system, where the geographical region in which one communication device is located may be assigned a first frequency band for wireless communication from and devices located in a neighbouring geographical region of space may be assigned a different frequency band for wireless communication. A communication device that is located close to the edge of another cell may be within communication range of a device located within that other cell, but will not be able to establish communication with it because the two devices have been assigned different communication channels from one another. In effect, therefore, the edge defines a border beyond which the communication device is unable to communicate with other devices, regardless of how close together they may be located geographically.

The extent to which a given communication device's communication range is modified may vary depending on the physical topology in the immediate vicinity of the communication device, and can be specified by a number of parameters including, for example, the prevailing channel conditions, the inherent path loss experienced at the communication device, and the available communication area of the communication device. In this way, it becomes possible to define a position-dependent communication range.

Adaptation can be performed dynamically if the channel conditions and/or the communication device's position or physical environment change. Such adaptation can be carried out using local information collected by each communication device in real-time.

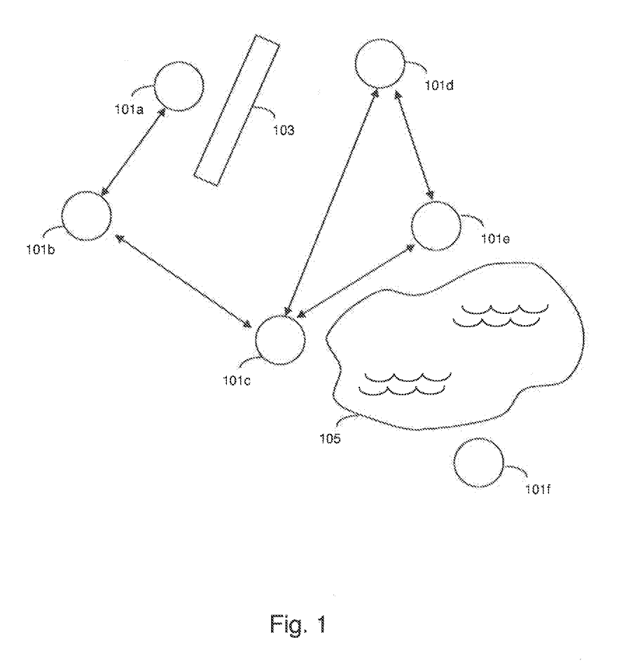

FIG. 1 shows an example of a wireless network comprising a plurality of wireless communication devices 101a-101f according to an embodiment. As shown, some of the devices are located in proximity to physical obstacles, such as a wall 103 and/or network deployment boundaries, such as a lake 105. Physical obstacles such as the wall 103 limit the size of a communication device's communication zone by blocking wireless signals that would otherwise have a longer range of propagation through space. Network deployment boundaries also limit the size of a communication device's communication zone, as by definition they preclude other communication devices from being located in the vicinity and relaying data to and from that device. Referring to FIG. 1, the lake 105 provides an example of a network deployment boundary that limits the size of the communication zones of the respective devices 101c, 101e and 101f; the lake comprises a region of space in which it is not possible (or at the least, unlikely) for other communication devices to be located. The transmitter and/or receiver settings of the various communication devices may be adjusted to accommodate their position with respect to these obstacles/boundaries.

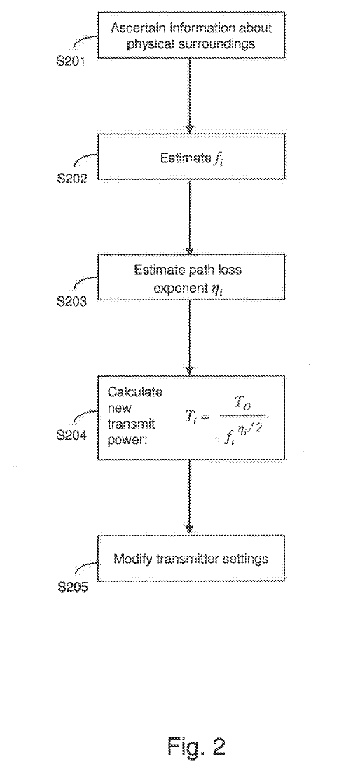

FIG. 2 shows a series of steps as executed by a wireless communication device in accordance with an embodiment. In this embodiment, the transmitter settings are modified to take account of the communication device's location within the physical environment; for example, the transmission power of the device i is adjusted to take account of a physical obstruction (e.g. a wall or large object) that defines a border of the device's communication zone.

Starting in step S201, the communication device ascertains information about its physical surroundings. In some embodiments, the device may determine its position coordinates through use of e.g. Global Positioning System (GPS) information or Indoor Positioning System (IPS) information and cross reference this with cartographic data to identify physical features in the device's surroundings (e.g. walls, buildings) as well as geographic features (e.g. lakes, regions of woodland etc). At the same time, where the device is operating within a cellular network, it may identify its position relative to the edge of any neighbouring network cells inside of which communication devices will be operating on a different frequency from that which the device itself is using. The cartographic data and/or data concerning the geographical distribution of the network cells may, for example, be pre-stored in the device's memory, or downloaded from a remote database.

In other embodiments, the communication device may identify physical obstacles in its surroundings through use of a ranging system such as RADAR, LIDAR, SONAR. In such cases, the communication device will issue one or more interrogation signals and use any ensuing reflected signals to infer information about the size and location of physical features in the environment.

Regardless of which particular method is used to determine the layout of the communication device's vicinity, the device may use that information to determine the presence of any borders of the communication zone.

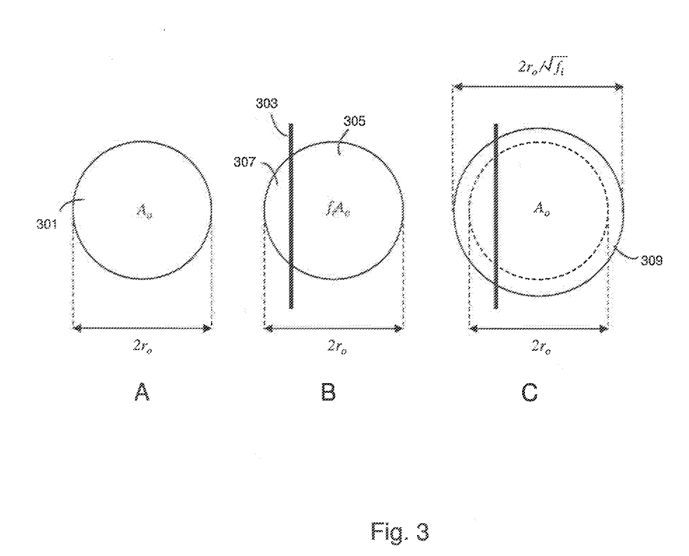

Having obtained the information about the physical environment, the communication device determines the extent to which the transmission power of the communication device needs to be adjusted to compensate for physical obstacles and or network deployment boundaries. To do so, the communication device determines a value for fᵢ, where fᵢ is a parameter that defines the extent to which the communication zone of the communication device i is likely to be reduced when those borders are taken into consideration. FIG. 3 shows an example of how the value of fᵢ may be determined. Referring to FIG. 3A, if the default communication range for an unobstructed isotropically radiating communication device i is taken to be r₀ meters, it is possible to define a communication zone 301 with area A₀=πr₀². If it is now assumed that the communication device is close to some obstacle, such as a wall 303 (see FIG. 38), the communication device will be physically restricted from sending and/or receiving communications. The effective size of the communication device's communication zone 305 will be reduced to fᵢA₀, where fᵢϵ(0,1). Another way of looking at this is to consider that the wall will remove a portion 307 of the communication device's original communication zone 301, where the size of that portion is equal to A₀(1−fᵢ).

It can be seen that in order for the communication device to maintain the size of its original communication zone, the communication device will need to increase its communication range to rᵢ=r₀/\sqrt{fᵢ}. For example, if the communication device is close to a wall that halves the area of its communication zone (fᵢ=½), then the communication device will need to aim to increase its communication range by a factor of \sqrt{2}. FIG. 3C illustrates how by increasing the range by a factor of \sqrt{2}, the increase in area of the communication zone 309 in the region in front of the wall is great enough to offset the area located behind the wall. The precise value of fᵢ that is determined in step S202 will depend on the shape of the obstacle or border and the communication device's position relative to that obstacle or border.

Next, in order to adjust the transmission power appropriately, the communication device will need to determine a local path loss exponent experienced by the communication device when sending transmissions (step S203). In order to explain this, it is helpful to consider the Friis Transmission equation which defines the theoretical maximum communication range rᵢⱼ (measured in meters) between two communication devices i and j:

$${r}_{ij} = {( {( \frac{λ}{4 π} )}^{2} \frac{{T}_{i}}{{R}_{j}} )}^{1 / {η}_{i}}$$

Here, Tᵢ is the transmission power of communication device i, Rⱼ is the receiver sensitivity power of communication device j, λ is the transmission wavelength in meters, and ηᵢ is the local path loss exponent experienced by the transmitting communication device i.

By adjusting the value of Tᵢ and for Rⱼ, it is possible to compensate for the communication region restriction factor fᵢ. Here, it is sufficient to note that:

rᵢⱼ∝(Tᵢ/Rⱼ)^{1/η}^{ᵢ}.

The path loss exponent ηᵢ itself may be estimated according to one of any number of conventional techniques, as described, for example, in “Path loss exponent estimation in large wireless networks” in Information Theory and Applications Workshop, 2009. IEEE, 2009. Note also that rᵢⱼ≠rⱼᵢ in general. The effects of impedance mismatch, misalignment of the antenna polarization, and absorption can be included in the above equation, leading to a modified version which in some instances can be more accurate in estimating the theoretical maximum communication range rᵢⱼ.

As discussed above, in order for a communication device that is located in close proximity to a network border or obstacle to maintain the same size of communication zone as one located distant from any such borders, the communication device will need to increase its communication range to:

rᵢ=r₀/\sqrt{fᵢ}

If the radius r₀ is taken to be that which is achieved when the transmit power of the communication device is set at a default T₀, then it can be seen from the equations above that the area of the communication zone of an obstructed communication device can be made similar to that of an unobstructed communication device by boosting its transmission power to Tᵢ, where

$${T}_{i} = \frac{{T}_{0}}{{f}_{i}^{{η}_{i} / 2}}$$

Thus, having calculated a new value for the transmitter power in step S204, the communication device proceeds to modify the transmitter power, increasing the default power by a factor of fᵢ^{-η}^{ᵢ}^{/2} (step S205).

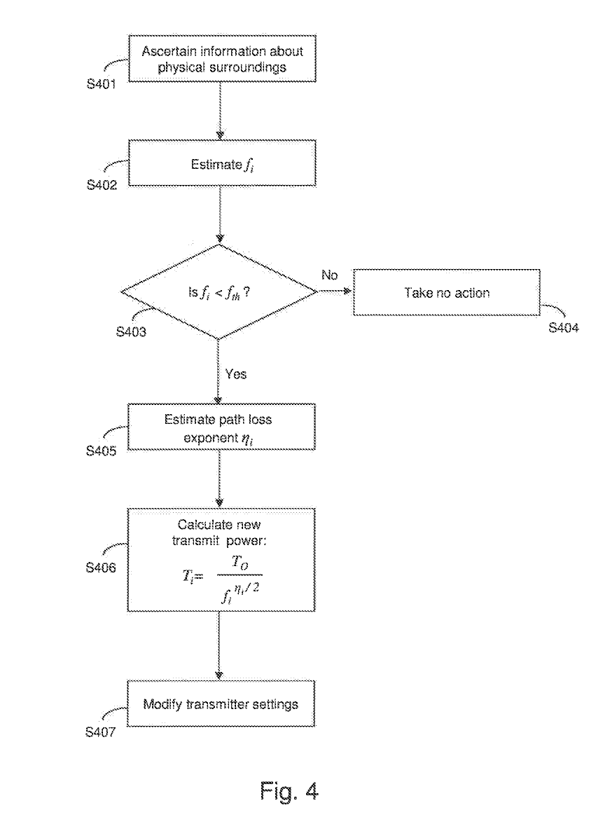

In some embodiments, a self organizing network may determine that the system parameters (i.e. location, path loss exponent) have changed only marginally. In such cases, it may be counterproductive to alter the transmitter properties as described above since doing so would require unnecessary overheads. Therefore, in some embodiments, a threshold value for fᵢ may be set, beneath which no action is taken, in order to avoid unnecessary reconfigurations. The threshold value for fᵢ may be defined such that transmitter settings are only modified in the event that the perceived reduction in the size of the communication zone owing to border effects is above a threshold. FIG. 4 shows an example of how this may be implemented. Here, steps S401 and S402 are identical to steps S201 and S202 of FIG. 2. However, before estimating the path loss exponent, a determination is made as to whether or not the value of fᵢ is above that of a threshold fₜₕ. In the event that fᵢ<fₜₕ, the method proceeds to step S404, with no action being taken to modify the transmitter settings. In the event that fᵢ>fₜₕ, the method proceeds as before in FIG. 2, with steps S405 to S407 corresponding to steps S203 to S205, respectively.

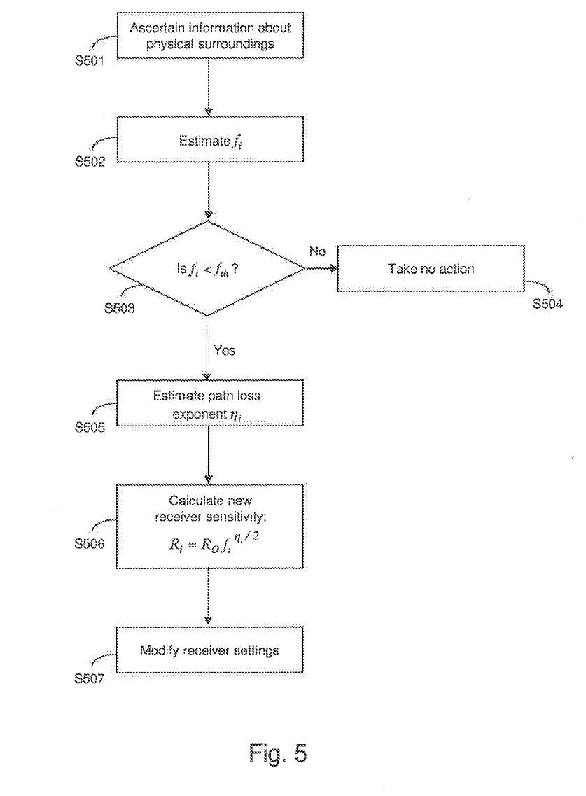

An embodiment will now be described with reference to FIG. 5, in which the receiver settings, rather than the transmitter settings are modified. As in the embodiments previously described, the communication device begins by ascertaining information about the physical surroundings (step S501) and using that information to estimate a value for the parameter fᵢ (step S502). In step S503, a decision is made as to whether the value of fᵢ>fₜₕ. In the event that fᵢ>fₜₕ, the communication device proceeds to estimate the path loss exponent (step S505); otherwise, no further action is taken (step S504).

Returning to the Friis Transmission equation above, it can be seen that if the default receiver sensitivity is taken to be R₀, then the size of the communication zone of a communication device that is located in close proximity to a network border or obstacle can be made similar to that of a communication device that is located distant from any such borders by reducing the receiver sensitivity power to Rᵢ, where:

Rᵢ=fᵢ^{η}^{ᵢ}^{/2}R₀

Accordingly, in step S506, the receiver sensitivity is determined using the above equation, after which the appropriate changes are made to the receiver settings in step S507. (It will be understood here that, as in the case where the transmitter settings are modified, the use of a threshold fₜₕ is an optional feature and steps S503 and S504 need not be included in all embodiments).

An approach in which the receiver settings alone are modified could be suitable in the case where a communication device is mostly used as a sink, i.e. where the communication device rarely transmits information. In this instance, having the capability of adapting in the receiver chain may be preferable, helping to limit the complexity of the communication device since a simple transmit chain can be used in which the communication device is only required to transmit at one power level, for example. Conversely, making adjustments to the transmitter settings alone may be preferred where a particular communication device is determined to be used mostly as a source of transmissions, rather than a sink.

Another example of where an unequal approach to adaptation would prove useful would arise in certain system configurations where antenna-to-power-amplifier matching in the transmitter could be problematic. In this case, antenna designs may be restricted for the transmitter, but the receive chain could be more forgiving to the antenna design, and thus more designs (and more possible modes of sensitivity) would be supported.

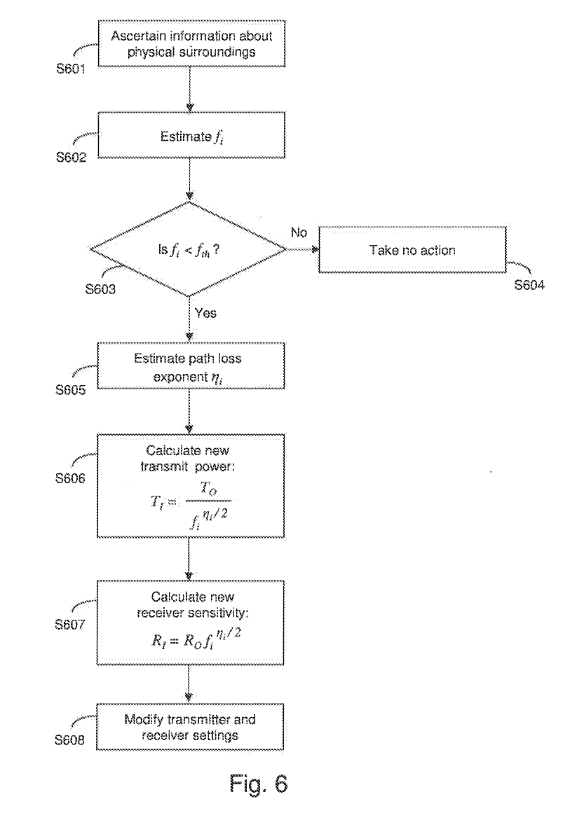

FIG. 6 shows a series of steps as executed by a wireless communication device in accordance with another embodiment. In this embodiment, both the transmitter and receiver settings are modified to take account of the communication device's location within the physical environment; that is, new values for both the transmitter power and the receiver sensitivity are calculated and the settings modified accordingly. Adjusting both the transmitter and receiver settings may provide additional benefits; for example, a balanced solution between transmit and receiving chains may in some instances minimise fabrication costs, by reducing the need for high quality heat sinks.

Although the scaling laws above relate to transmission power/receiver sensitivity, it will be appreciated from the Friis transmission formula that the area of the communication zone can be modified by applying similar scaling laws to several other key system parameters such as carrier frequency/wavelength and antenna gain, for example. The communication device may alter its individual transmit power, receiver sensitivity, or both, using one of several approaches including, for example, the use of reconfigurable amplifiers, variable band pass filters, automatic gain-controllers, demodulation/modulation and diversity coding techniques.

In some embodiments, a look up table may be employed if the device can only operate at a discrete set of Tᵢ and/or Rᵢ values; the communication device may assess the likely reduction in the size of its communication zone due to an obstacle and select the value of Tᵢ and/or Rᵢ from the look-up table that best matches the actual value required to compensate for that reduction in size.

Embodiments described herein allow for improvement in network connectivity, reliability and cost and energy efficiency. Embodiments facilitate the flexible configuration and operation of a network such that it can adapt from preset conditions. For example, if a mobile unit determines that its transmission range is confined by obstacles, it can boost its communication range appropriately such that it covers approximately the same communication region as if it was in an open space. In doing so, the unit will reduce the probability of its becoming isolated (in a communication sense) from other units. As this process operates at the lowest level within any network communication system, it can enhance the stability and performance of medium access control (MAC) and network layer protocols with minimal compatibility issues.

The utility of the present embodiment can be demonstrated by considering an example network of N communication devices in a circular domain of area A=200 m², where the default communication range of each communication device is set at r₀=1 m. For convenience, the spatial distribution of the communication devices at some instant of time will be assumed to be uniform, from which it follows that a typical communication device away from the domain border will have

$$\frac{N π {r}_{0}^{2}}{A}$$

communication links to its nearest neighbours. Communication devices near the border however will typically have less than this and hence depending on the value of N may have no communication links at all, isolating them from the rest of the network. Specifically, communication devices which are extremely close to the domain border will typically have

$$\frac{N π {r}_{0}^{2} / 2}{A}$$

communication links since fᵢ≈½.

One solution for increasing the connectivity would be to increase the number of communication devices N. The larger the value of N, the less likely it is that a particular communication device will be isolated. It can be shown that the probability of an isolated communication device decays as

$$\frac{\sqrt{π A}}{{r}_{0}} exp ( - \frac{N π {r}_{0}^{2} / 2}{A} )$$

for large enough values of N. From this point of view, increasing the number of communication devices by a significant amount would serve to alleviate the effects of obstacles/borders. However, increasing the number of communication devices in this way can be highly undesirable as it incurs additional costs, interference, and overheads.

In contrast, in embodiments described herein, communication devices located close to a border or obstacle can increase their number of outgoing or incoming communication links by modifying the transmitter and/or receiver settings appropriately. The strategy may be employed locally within a small subset of communication devices, with minimal communication overheads. Moreover, the additional energy requirements of these communication devices should over time average out, assuming that the communication devices' mobility within the network spatial domain is ergodic.

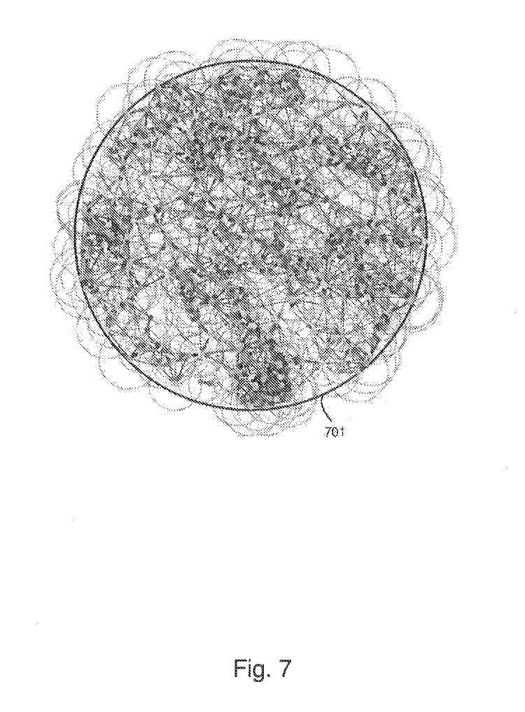

As an example of how the communication range of communication devices may be increased to alleviate border effects, FIG. 7 shows a network of 400 communication devices, each one of which has a communication range illustrated by a surrounding circle. As can be seen, communication devices near the deployment boundary 701 have a larger communication range, as indicated by the larger radius of their surrounding circles.

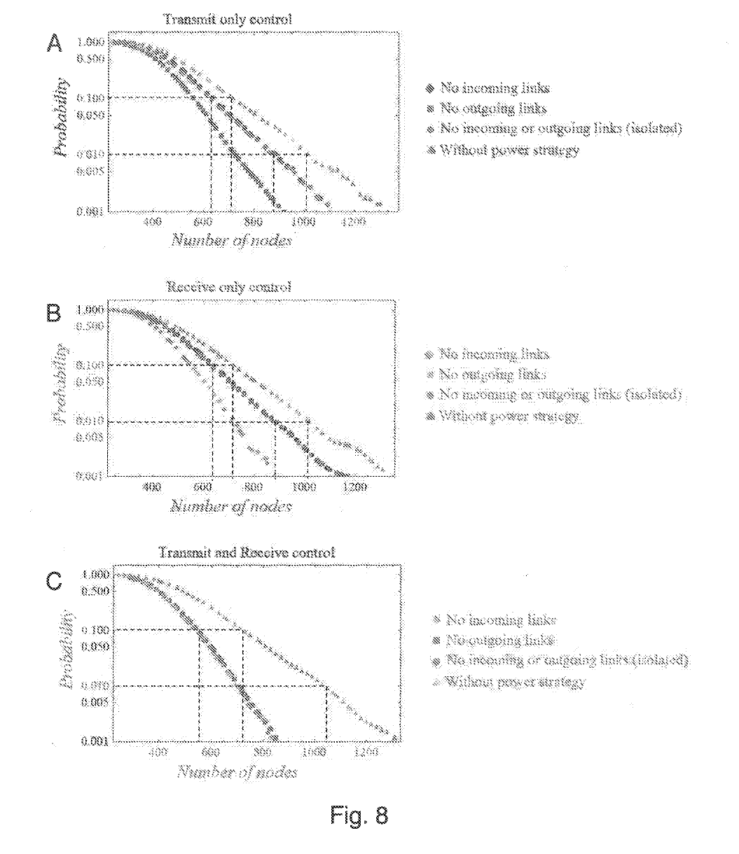

Reference is now made to FIGS. 8A, 8B and 8C, which show results of simulations of how the probability of a network communication device becoming isolated varies with the number of communication devices in the network of FIG. 7. FIGS. 8A, 8B and 8C show, respectively, results for the three cases in which the transmitter settings alone are modified, the receiver settings alone are modified, and both the transmitter and receiver settings are modified. Each figure plots the probability that at least one of the communication devices in the network of FIG. 7 will have a) no incoming links, b) no outgoing links and c) no incoming or outgoing links, in which case the communication device is considered to be isolated. As a benchmark for comparison, each figure also shows the probability that a communication device will have no incoming or outgoing links in the case when neither the transmitter settings, nor the receiver settings are modified.

FIGS. 8A, 8B and 8C demonstrate how embodiments described herein can increase the network connectivity compared to conventional approaches. For example, referring to FIG. 8A, it can be seen that in the case where neither the transmitter settings nor the receiver settings are modified, the probability of a communication device in a network of 1000 communication devices becoming isolated is 1%. In contrast, where the transmitter power is modified in accordance with an embodiment described herein, the probability that a communication device in a network of 1000 communication devices will become isolated falls to 0.3%. When employing such an approach, it is only when the number of communication devices in the network falls beneath 900 that the probability of a communication device becoming isolated reaches 1%; thus, when compared to a conventional approach, it is possible to keep the probability of a communication device becoming isolated at the same level, with a 10% reduction in the overall number of communication devices in the network.

It will be observed that in terms of preventing a communication device from becoming isolated, the approaches shown in FIGS. 8A and 8B, in which the transmitter and receiver settings are respectively adjusted, lead to the same outcome; this is to be expected as the two cases are, in a sense, symmetrical, with the probability that a communication device will fail to establish any incoming or outgoing links simply being interchanged between the two cases. By contrast, in the case in which both the transmitter and receiver settings are modified (FIG. 8C), the border effects are alleviated completely.

Tables 1 and 2 below show the reduction in the number of communication devices required to achieve different values of communication device isolation probabilities. For each entry in Table 1, dashed lines are shown at the corresponding number of communication devices in FIGS. 8A, 8B and 8C. The benefit of modifying the transmitter and/or receiver settings in accordance with the described embodiments is shown in this example by the significant reduction in the total number of communication devices that is required in order to reduce the probability of an isolated communication device. For instance, in the case where both the transmitter and receiver settings are modified, only 900 communication devices randomly distributed in a circular domain such as that of FIG. 7 are needed to guarantee an isolation probability of 0.1% (i.e. full connectivity of approximately 99,9%), as opposed to 1330 communication devices (i.e. 430 less) in the case where neither the transmitter settings nor the receiver settings are modified.

TABLE 1
The number of communication devices that are required in the
network in order to ensure the probability of an individual
communication device becoming isolated remains below a
given value, for cases in which the transmitter and/or receiver
settings are modified (second, third and fourth columns), and in
which neither of those settings are modified (fifth column).

| | | | Transmitter | Neither transmitter |
|---|---|---|---|---|
| | Transmitter | Receiver | and receiver | nor receiver |
| Isolation | settings | settings | settings | settings |
| probability | modified | modified | modified | modified |
| 10% | 640 | 640 | 550 | 710 |
| 1% | 890 | 890 | 710 | 1010 |
| 0.1% | 1100 | 1100 | 900 | 1330 |

TABLE 2
This table shows the number of communication devices in each
column of Table 1 as a percentage of those required for the case in
which neither the transmitter nor the receiver settings are modified.

| | Transmitter | | Transmitter and |
|---|---|---|---|
| Isolation | settings | Receiver | Receiver |
| probability | modified | settings modified | settings modified |
| 10% | 90.1% | 90.1% | 77.4% |
| 1% | 88.1% | 88.1% | 70.2% |
| 0.1% | 82.7% | 82.7% | 67.7% |

It will be understood that the circular example shown in FIG. 7 (on which the simulations of FIG. 8 are based) is just one of many possible scenarios and one in which the border effects are minimal due to the absence of corners. In more complex domains such as irregular polygons with possibly internal large obstacles, border effects will undoubtedly undermine network connectivity significantly. The embodiments described above will be equally applicable strategy outlined in this invention can easily be applied in such scenarios, thus offering significant reliability improvements as well as reductions in necessary communication device numbers and therefore costs.

Embodiments described herein can also provide benefits when combined with existing algorithms that switch off sensors in order to preserve energy and extend network lifetime. Here, the added power consumption of border communication devices is compensated by rendering a large number of non-border communication devices unnecessary. These communication devices can therefore be switched-off and hence preserve power, only to be switched back on at a later stage.

Embodiments described herein provide further utility from the perspective of flooding algorithms. Flooding is a simple broadcasting algorithm in which every incoming packet is relayed through every outgoing link except the one it arrived from, with the result that every message is eventually delivered to all reachable parts of the network. A subset of the network will only be reachable using flooding algorithms if there is at least one multi-hop path from the source communication device to every other communication device in the network. Strong connectivity (a close relative to full connectivity for undirected graphs) is a network condition for directed graphs (digraphs) requiring that a communication path (or route) exists between any two communication devices. Hence, flooding is possible, provided the network is strongly connected.

Dense networks with a high communication device degree (i.e. a high average number of 1-hop neighbours) are prone to a high number of a) redundant re-broadcasts, b) contentions, and c) collisions. Collectively these issues are referred to as the broadcast storm problem. A large number of protocols exist utilizing a variety of techniques aiming at calming the storm. These protocols include counter-based schemes e.g. CSMA/CA, probabilistic schemes, distance-based schemes and location-based schemes. Energy management and routing schemes also help in alleviating the broadcast storm problem. For example, a number of communication devices may be interchangeably put to sleep (low energy mode), using some energy cost function that is optimized so as not to compromise the network functionality.

The protocols mentioned above are only useful if connectivity between communication devices can be ensured at the most basic level. In other words, one must be able to guarantee that a given communication device can communicate with any other given communication device in a network with a certain positive probability. This guarantee defines a notion of reliability and is equivalent to that of strong connectivity, which embodiments described herein aim at enhancing using topology control techniques. Since flooding is a low-level primitive, enhancing it through these embodiments can drastically improve the overall performance of any higher level operation of wireless ad hoc networks.

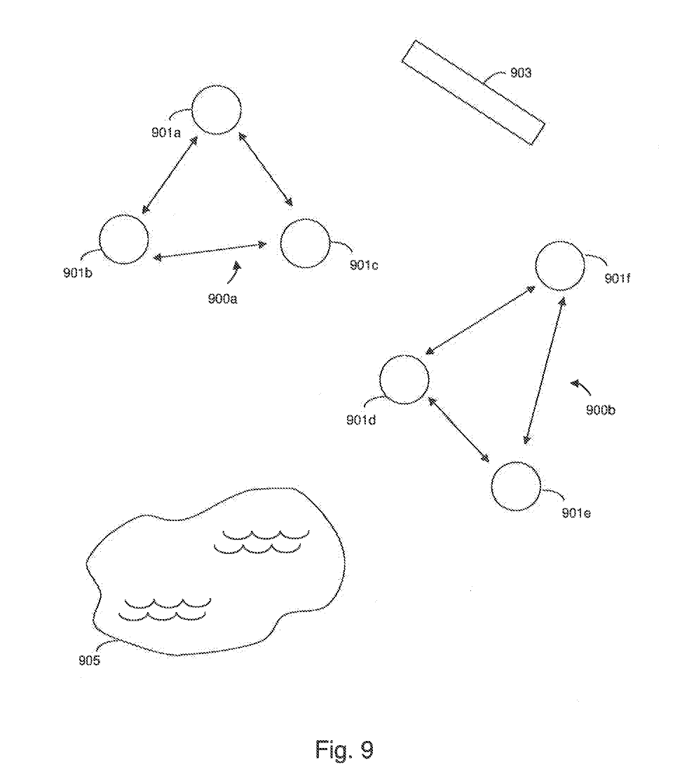

A further embodiment of the invention will now be described in which high connectivity between communication devices may be undesired. FIG. 9 shows an example of two groups of communication devices 900a, 900b that form respective networks. The first network comprises communication devices 901a, 901b and 901c, whilst the second network comprises communication devices 901d, 901e and 901f. In the present embodiment, it is desirable that transmissions between the first group of communication devices 900a should not be detected at the second group of communication devices 900b, and vice versa, in order to avoid unnecessary interference, or to protect the privacy of data being transmitted.

As in the case of FIG. 1, the communication devices are located in physical terrain that contains a communication barrier in the form of a wall 903 and a lake 905 that defines a network deployment boundary, for example. As in the previous described embodiments, each communication device surveys its surroundings, in order to identify any borders that limit the extent of its communication zone. In this case, the communication devices are all located distant from the wall and lake, meaning that the communication zone of each respective device is unlikely to be affected by those features. On determining that the communication zone of each respective device is unlikely to be affected by those features, the communication devices may adjust their transmitter and or receiver settings to reduce their communication range, thereby reducing the chance of eavesdropping and/or exposing neighbours to interference. In particular, the respective groups of communication devices 900a, 900b may adjust their respective settings so as to ensure that each communication device only receives signals from the other communication devices in its own group, and avoids interfering with, or eavesdropping on, the communication devices in the other group.

Embodiments are suitable for self-organising large scale wireless networks, and can enhance network routing efficiency and network lifetime.

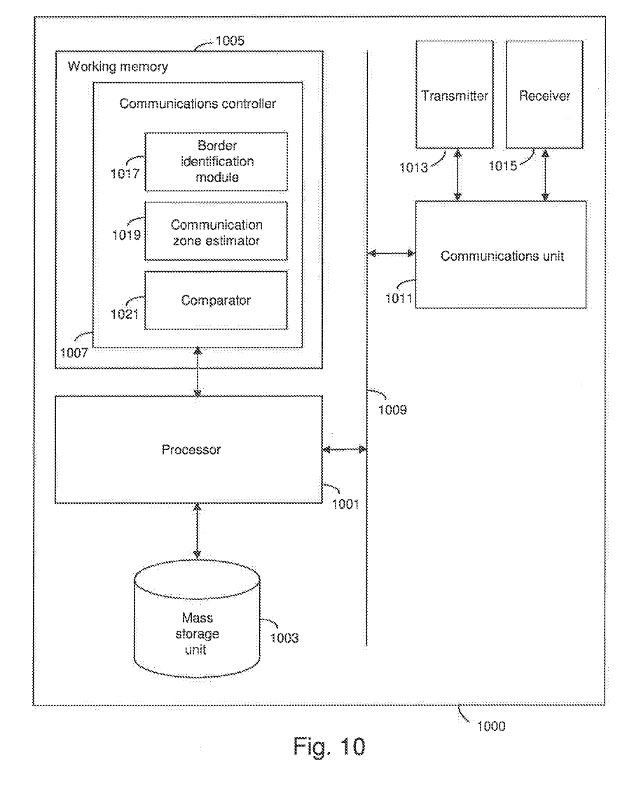

While the reader will appreciate that the above embodiments are applicable to any communication device having the capability to transmit and/or receive data over a wireless network, a typical communication device is illustrated in FIG. 10, which provides means capable of putting an embodiment, as described herein, into effect. As illustrated, the device 1000 comprises a processor 1001 coupled to a mass storage unit 1003 and accessing a working memory 1005. As illustrated, a communications controller 1007 is represented as a software product stored in working memory 1005. However, it will be appreciated that elements of the communications controller 1007 may, for convenience, be stored in the mass storage unit 1003.

Usual procedures for the loading of software into memory and the storage of data in the mass storage unit 1003 apply. The processor 1001 also accesses, via bus 1009, a communications unit 1011 that operates to effect communications with the wireless network, via a transmitter 1013 and receiver 1015 (the transmitter and receiver may be provided as separate components or as a single transceiver).

The communications controller 1007 itself includes several modules that allow the communication device to accommodate the presence of obstacles in its vicinity by implementing steps described above in relation to the various embodiments. These modules include a border identification module 1017, a communication zone estimator 1019 and a comparator 1021.

The border identification module 1017 is operable to establish the presence of any borders that limit the communication zone of the device. In some embodiments, the receiver 1015 may function to provide GPS data to the border identification module 1017, which may then use that data to establish the presence of borders in the immediate location by referencing cartographic data retrieved from the mass storage unit or alternatively downloaded from the network via the receiver 1015. Alternatively, or in addition, the border identification module may identify the proximity of obstacles by use of direct ranging measurements e.g. by analysing the amplitude and/or arrival time of signals reflected by obstacles in the surrounding environment when one or more interrogation signals are transmitted from the communication device.

Once the presence of such borders have been identified, the communication zone estimator 1019 is operable to estimate the size of the device's effective communication region, taking into account those borders. The comparator 1021 in turn operates to determine whether or not it is necessary to increase (or decrease) the communication range of the device. In the event that a change in transmitter and/or receiver settings is required, the change can be effected by forwarding the necessary data to the communications unit 1011.

Thus, execution of the communications controller software 1007 by the processor 1001 will cause embodiment as described herein to be implemented. The communications controller software 1007 can be embedded in original equipment, or can be provided, as a whole or in part, after manufacture. For instance, the communications controller software 1007 can be introduced, as a whole, as a computer program product, which may be in the form of a download, or to be introduced via a computer program storage medium, such as an optical disk. Alternatively, modifications to an existing communications controller 1007 can be made by an update, or plug-in, to provide features of the above described embodiment.

While certain embodiments have been described, these embodiments have been presented by way of example only, and are not intended to limit the scope of the invention. Indeed, the novel methods, devices and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the inventions.

1. A wireless communication device for communicating with one or more other wireless communication devices in a wireless network, the wireless communication device having:
a transmitter and/or receiver for respectively transmitting or receiving communication signals to or from the other communication devices;
a border identification module for identifying one or more borders of a communication zone of the communication device, wherein the communication zone defines a region of space in which other communication devices in the network are potentially located and within which those other communication devices will be in direct communication range of the communication device;
a communication zone estimator for estimating the size of the communication zone when taking into account any identified borders; and
a controller for modifying the settings of the transmitter and/or the receiver based on the estimated size of the communication zone.

2. A communication device according to claim 1, wherein the border identification module is configured to identify as a border the edge of another region of space that has been allocated for use by other communication devices with which said communication device is unable to establish direct communication.

3. A communication device according to claim 2, wherein the transmitter and/or receiver are respectively configured to transmit or receive communication signals on a specified channel, and wherein the other region of space is allocated to communication devices that have been assigned a different channel from the specified channel.

4. A communication device according to any one of the preceding claims, wherein the controller is configured to modify the settings of the transmitter and/or the receiver in such a way as to increase the communication range of the device.

5. A communication device according to any one of the preceding claims, wherein the controller is configured to modify the settings of the transmitter and/or the receiver in such a way as to reduce the communication range of the device.

6. A communication device according to any one of the preceding claims, wherein the one or more borders include a physical feature in the vicinity of the device that is likely to block the passage of communication signals between the device and other communication devices; and/or a deployment boundary of the wireless network.

7. A communication device according to claim 6, wherein the border identification module is configured to identify a geographic feature of the surrounding landscape as a network deployment boundary.

8. A communication device according to claim 6, further comprising a comparator for comparing the estimated size of the communication zone with the size of the communication zone that the communication device would be expected to have in the absence of the identified borders.

9. A communication device according to claim 8, wherein the controller is configured to determine whether or not to modify the settings of the transmitter and/or the receiver by determining if the difference between the estimated size of the communication zone and the size of the communication zone that the communication device would be expected to have in the absence of the identified borders is above a threshold.

10. A communication device according to any one of the preceding claims, wherein the communication device includes a transmitter and the controller is configured to modify the transmitter settings by modifying one or more of the carrier frequency, wavelength and amplitude of signals sent from the transmitter.

11. A communication device according to any one of the preceding claims, wherein the communication device includes a receiver and the controller is configured to modify the receiver settings by modifying the sensitivity of the receiver.

12. A communication device according to any one of the preceding claims, wherein the controller is configured to modify the power of the transmitter and/or the sensitivity of the receiver by reference to a look-up table.

13. A communication device according to any one of the preceding claims, wherein the communication device includes both a transmitter and a receiver and the controller is configured to modify both the settings of the transmitter and the receiver based on the estimated size of the communication zone.

14. A wireless network comprising a plurality of communication devices according to claim 1.

15. A method of managing connectivity between wireless communication devices in a wireless network, the method comprising:
identifying one or more borders of a communication zone of a first wireless communication device, wherein the communication zone defines a region in which other communication devices in the network are potentially located and within which those other communication devices will be in direct communication range of the first communication device;
estimating the size of the communication zone when taking into account any identified borders; and
modifying the settings of the transmitter and/or the receiver based on the estimated size of the communication zone.

16. A non-transitory computer readable storage medium comprising computer executable instructions that when executed by a computer will cause the computer to carry out the method of claim 15.
